(19) United States
(12) Patent Application Publication
(10) Pub. No.: US 2025/0348995 A1
(43) Pub. Date: Nov. 13, 2025

(54) METHOD OF INSPECTING A COMPOSITE COMPONENT

(71) Applicant: General Electric Company, Evendale, OH (US)

(72) Inventors: Shatil Sinha, Clifton Park, NY (US); James Robert Kubricht, Austin, TX (US); Feng Xue, Clifton Park, NY (US)

(21) Appl. No.: 19/201,535

(22) Filed: May 7, 2025

Related U.S. Application Data
(60) Provisional application No. 63/643,655, filed on May 7, 2024.

(51) Int. Cl. G06T 7/00; B29C 37/00

(52) U.S. Cl. CPC G06T 7/001; B29C 37/00; B29C 2037/906; G06T 2207/30108

(57) ABSTRACT

A method of inspecting a composite component having a plurality of composite plies.

The method includes capturing an image of a cross section of the plurality of composite plies, the image including light reflection patterns corresponding to a plurality of reinforcing fibers within the composite plies of the composite component, identifying key points of the composite component on the image to define an area of interest, generating a plurality of profile lines in the image, processing along each of the plurality of profile lines to identify patterns corresponding to a layup of the plurality of reinforcing fibers, grouping identified patterns from the plurality of profile lines, comparing the identified patterns to an as-expected template of the plurality of composite plies in the composite component to evaluate a manufacturing process of the composite component, and determining whether the identified patterns match the as-expected template.

### CROSS REFERENCE TO RELATED APPLICATIONS

The present application claims the benefit of U.S. Provisional Patent Application No. 63/643,655, filed on May 7, 2024, which is hereby incorporated by reference herein in its entirety.

### TECHNICAL FIELD

The present disclosure relates generally to a method of inspecting a composite component.

### BACKGROUND

Many components in aircrafts or other components of devices can be made at least partially from composite materials, such as carbon fiber reinforced materials. For example, fan blades of turbine engines can be made from a layup of plies of composite material. During manufacturing of the components, a specific sequencing of the layup of plies is used depending on the intended use of the components. After manufacture, the components (e.g., fan blades) are inspected to identify anomalies. Various validations on correct sequencing of the layup of plies of the composite material are often made to ensure the layup of plies of the composite material satisfies desired specifications for the components. For example, the layup of plies of composite material may be inspected visually to determine whether an anomaly or discrepancy may be present in the composite material. The layup of plies of the composite material may also be inspected to identify any out of sequence plies and to confirm that a correct number of plies are used.

### BRIEF DESCRIPTION OF THE DRAWINGS

Features and advantages will be apparent from the following, more particular, description of various exemplary embodiments, as illustrated in the accompanying drawings, wherein like reference numbers generally indicate identical, functionally similar, and/or structurally similar elements.

FIG. 1 is a schematic cross-sectional view of a turbine engine, according to an embodiment of the present disclosure.

FIG. 2 is a partial cross-sectional view of a dovetail portion (root portion) of a fan blade, according to an embodiment of the present disclosure.

FIG. 3A is an image of a first flat face of a dovetail of a fan blade, according to an embodiment of the present disclosure.

FIG. 3B is an enlarged portion of the image shown in FIG. 3A, according to an embodiment of the present disclosure.

FIG. 4 is a plot of the pixel intensity versus a distance along a profile line, according to an embodiment of the present disclosure.

FIG. 5 is a plot of identified wider peak locations for a plurality (e.g., twenty) profile lines versus a distance along each of the plurality of profile lines, according to an embodiment of the present disclosure.

FIG. 6 is a plot of density estimation and density peaks versus the distance along the plurality of profile lines, according to an embodiment of the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first” and “second” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the term “axial” refers to directions and orientations that extend substantially parallel to a centerline of the turbine engine. Moreover, the terms “radial” refers to directions and orientations that extend substantially perpendicular to the centerline of the turbine engine. In addition, as used herein, the terms “circumferential” and “circumferentially” refer to directions and orientations that extend arcuately about the centerline of the turbine engine.

As used herein, the terms “low,” “mid” (or “mid-level”), and “high,” or their respective comparative degrees (e.g., “lower” and “higher”, where applicable), when used with compressor, combustor, turbine, shaft, fan, or turbine engine components, each refers to relative pressures, relative speeds, relative temperatures, or relative power outputs within an engine unless otherwise specified. For example, a “low-power” setting defines the engine or the combustor configured to operate at a power output lower than a “high-power” setting of the engine or the combustor, and a “mid-level power” setting defines the engine or the combustor configured to operate at a power output higher than a “low-power” setting and lower than a “high-power” setting. The terms “low,” “mid” (or “mid-level”) or “high” in such aforementioned terms may additionally, or alternatively, be understood as relative to minimum allowable speeds, pressures, or temperatures, or minimum or maximum allowable speeds, pressures, or temperatures relative to normal, desired, steady state, etc., operation of the engine. A mission cycle for a turbine engine includes, for example, a low-power operation, a mid-level power operation, and a high-power operation. Low-power operation includes, for example, engine start, idle, taxiing, and approach. Mid-level power operation includes, for example, cruise, and high-power operation includes, for example, takeoff and climb.

The various power levels of the turbofan engine are defined as a percentage of a sea level static (SLS) maximum engine rated thrust. Low-power operation includes, for example, less than thirty percent (30%) of the SLS maximum engine rated thrust of the turbofan engine. Mid-level power operation includes, for example, thirty percent (30%) to eighty-five percent (85%) of the SLS maximum engine rated thrust of the turbofan engine. High-power operation includes, for example, greater than eighty-five percent (85%) of the SLS maximum engine rated thrust of the turbofan engine. The values of the thrust for each of the low power operation, the mid-level power operation, and the high-power operation of the turbofan engine are exemplary only, and other values of the thrust can be used to define the low-power operation, the mid-level power operation, and the high-power operation.

The terms “coupled,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, a “turbo-engine” includes a compressor section, a combustion section, and a turbine section.

As used herein, a “turbofan engine” includes a turbo-engine and a fan that directs air into the turbo-engine, and rated for use in a regional aircraft, narrow body aircraft, or wider body aircraft. A turbofan engine rated for use on a regional aircraft will have a maximum takeoff thrust in a range of ten thousand pound-force to twenty thousand pound-force (10,000 lbf to 20,000 lbf). A turbofan engine rated for use on a narrow body aircraft will have a maximum takeoff thrust in a range of fifteen thousand pound-force to thirty thousand pound-force (15,000 lbf to 30,000 lbf). A turbofan engine rated for use on a wider body aircraft will have a maximum takeoff thrust in a range of forty thousand pound-force to one hundred ten thousand pound-force (40,000 lbf to 110,000 lbf).

As used herein, the term “ducted engine” means a turbofan engine with a fan casing or a nacelle that circumferentially surrounds the fan.

Hereafter, the term “turbofan engine” will refer to either a “ducted engine” or an “open fan engine.”

As used herein, a Mach number is a ratio of the speed of the turbofan engine (of the aircraft) to the speed of sound in the surrounding airflow.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

Various validations on correct sequencing of the layup of plies of composite material are often made to ensure the layup of plies of the composite material satisfies desired specifications of the components. For example, the plies of the composite material of the component are laid up in a desired alternating fashion according to the intended use of the component (e.g., a fan blade).

Light reflection patterns of a typical composite component are captured along a cross section of ply layers on an image. A pixel intensity along a profile line of the cross section reflects the alternating plies of the composite material in the component. A method is implemented to detect intensity variation along the profile line. For example, the intensity may vary based on a number of a same kind ply of the composite material placed or inserted on top of each other. By processing the intensity detected at a plurality of profile lines, a ply insert pattern of the component can be identified.

For example, in the case of a fan blade having a number of plies of the composite material, a double insert location can be identified based on the width of the signal peak along a profile line. The term “double insert” is used herein to mean two plies with fibers having a same orientation angle are laid next to each other. By grouping the identified double insert locations from the plurality of profile lines, double insert locations can be identified with high confidence. In the case of the fan blade, the identification of double insertion locations is referred to as density estimation. The identifications are compared with an as-expected template per component layup design specification. As a result, anomalous components can be identified in a controlled manufacturing process.

The method includes identifying key points of a component and generating a plurality of profile lines along a cross section of ply layers of an image taken at the key points of the component. The method also includes processing along each of the plurality of profile lines to identify patterns corresponding to ply layup. The identification of patterns can be associated with locations on the component. The method includes grouping the identification of patterns from the plurality of profile lines to form a basis for a confident layup pattern identification. The method includes ignoring noise identifications from individual profile lines. The method includes comparing the identified pattern to an as-expected template to evaluate the manufacturing of the component to make a decision on normal as opposed to abnormal.

The present method can be used to inspect aircraft component such as fan blades of a turbine engine of an aircraft or other components. The method can be used for inspection after manufacturing of a component or during manufacturing of the component. The method can be used for inspection of a component in-service for other defects. The method can be automated to provide inspection of components without intervention of a user or an operator. For example, the method can be implemented for a vision-based camera or other detection equipment.

The term “composite,” as used herein, is indicative of a component material having two or more constituent materials. A composite can be a combination of at least two or more metallic, non-metallic, or a combination of metallic and non-metallic elements or materials. Examples of a composite material can be, but not limited to, a polymer matrix composite (PMC), a ceramic matrix composite (CMC), a metal matrix composite (MMC), carbon fibers, a polymeric resin, a thermoplastic resin, bismaleimide (BMI) materials, polyimide materials, an epoxy resin, glass fibers, and silicon matrix materials. The composite may be formed of a matrix material and a reinforcing element, such as a fiber (referred to herein as a reinforcing fiber).

As used herein, “reinforcing fibers” may include, for example, glass fibers, carbon fibers, steel fibers, or para-aramid fibers, such as Kevlar® available from DuPont of Wilmington, Delaware. The reinforcing fibers may be in the form of fiber tows that include a plurality of fibers that are formed into a bundle. The polymeric matrix material may include, for example, thermoset resin, bismaleimide (BMI) materials, polyimide materials, or thermoplastic resin.

“Preform” as used herein is a piece of three-dimensional composite woven fabric formed by a plurality of reinforcing fibers including warp fiber tows and weft fiber tows.

As used herein, a “composite component” refers to a structure or a component including any suitable composite material. Composite components, such as a composite airfoil (e.g., a composite fan blade), can include several layers or plies of composite material (composite plies). The layers or plies can vary in stiffness, material, and dimension to achieve the desired composite component or composite portion of a component having a predetermined weight, size, stiffness, and strength.

One or more layers of adhesive can be used in forming or coupling composite components. Adhesives can include resin and phenolics, wherein the adhesive can require curing at elevated temperatures or other hardening techniques.

As may be used herein, PMC refers to a class of materials. The PMC material may be a prepreg. A prepreg is a reinforcement material (e.g., a reinforcing fiber) pre-impregnated with a polymer matrix material, such as thermoplastic resin. Non-limiting examples of processes for producing thermoplastic prepregs include hot melt pre-pregging in which the fiber reinforcement material is drawn through a molten bath of resin and powder pre-pregging in which a resin is deposited onto the fiber reinforcement material, by way of a non-limiting example, electrostatically, and then adhered to the fiber, by way of a non-limiting example, in an oven or with the assistance of heated rollers.

Resins for matrix materials of PMCs can be generally classified as thermoset resin polymers or thermoplastic resin polymers. Thermoplastic resin polymers are generally categorized as polymers that can be repeatedly softened and flowed when heated, and hardened, when sufficiently cooled due to physical rather than chemical changes. Notable example classes of thermoplastic resin polymers include nylons, thermoplastic polyesters, polyaryletherketones, and polycarbonate resins. A specific example of high-performance thermoplastic resins that have been contemplated for use in aerospace applications include polyetheretherketone (PEEK), polyetherketoneketone (PEKK), polyetherimide (PEI), polyaryletherketone (PAEK), and polyphenylene sulfide (PPS). In contrast, once fully cured into a hard rigid solid, thermoset resins do not undergo significant softening when heated, but instead, thermally decompose when sufficiently heated. Notable examples of thermoset resin polymers include epoxy, bismaleimide (BMI), and polyimide resins.

Instead of using a prepreg with thermoplastic polymers, another non-limiting example utilizes a woven fabric. A woven fabric can include, but is not limited to, dry carbon fibers woven together with thermoplastic polymer fibers or filaments. Non-prepreg braided architectures can be made in a similar fashion. With this approach, it is possible to tailor the fiber volume of the part by dictating the relative concentrations of the thermoplastic fibers and reinforcement fibers that have been woven or braided together. Additionally, different types of reinforcement fibers can be braided or woven together in various concentrations to tailor the properties of the part. For example, glass fibers, carbon fibers, and thermoplastic fibers could all be woven together in various concentrations to tailor the properties of the part. The carbon fibers provide the strength of the system, the glass fibers can be incorporated to enhance the impact properties, which is a design characteristic for parts located near the inlet of the engine, and the thermoplastic fibers provide the binding for the reinforcement fibers.

In yet another non-limiting example, resin transfer molding (RTM) can be used to form at least a portion of a composite component. Generally, RTM includes the application of dry fibers to a mold or a cavity. The dry fibers can include prepreg, braided material, woven material, or any combination thereof. Resin can be pumped into or otherwise provided to the mold or the cavity to impregnate the dry fibers. The combination of the impregnated fibers and the resin are then cured and removed from the mold. When removed from the mold, the composite component can require post-curing processing. RTM may be a vacuum assisted process. That is, the air from the cavity or the mold can be removed and replaced by the resin prior to heating or curing. The placement of the dry fibers can be manual or automated. The dry fibers can be contoured to shape the composite component or to direct the resin. Optionally, additional layers or reinforcing layers of a material differing from the dry fiber can also be included or added prior to heating or curing.

As used herein, CMC refers to a class of materials with reinforcing fibers in a ceramic matrix. Generally, the reinforcing fibers provide structural integrity to the ceramic matrix. Some examples of reinforcing fibers can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Some examples of ceramic matrix materials can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) can also be included within the ceramic matrix.

Generally, particular CMCs can be referred to as their combination of type of fiber/type of matrix. For example, C/SiC for carbon-fiber-reinforced silicon carbide, SiC/SiC for silicon carbide-fiber-reinforced silicon carbide, SiC/SiN for silicon carbide fiber-reinforced silicon nitride, SiC/SiC—SiN for silicon carbide fiber-reinforced silicon carbide/silicon nitride matrix mixture, etc. In other examples, the CMCs can be comprised of a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃.·2SiO₂), as well as glassy aluminosilicates.

In certain non-limiting examples, the reinforcing fibers may be bundled (e.g., form fiber tows) and/or coated prior to inclusion within the matrix. The bundles of fibers may be impregnated with a slurry composition prior to forming the preform or after formation of the preform. The preform may then undergo thermal processing, and subsequent chemical processing to arrive at a component formed of a CMC material having a desired chemical composition. For example, the preform may undergo a cure or a burn-out to yield a high char residue in the preform, and subsequent melt-infiltration with silicon, or a cure or a pyrolysis to yield a silicon carbide matrix in the preform, and subsequent chemical vapor infiltration with silicon carbide. Additional steps may be taken to improve densification of the preform, either before or after chemical vapor infiltration, by injecting the preform with a liquid resin or a polymer followed by a thermal processing step to fill the voids with the silicon carbide. A CMC material as used herein may be formed using any known or hereafter developed methods including, but not limited to, melt infiltration, chemical vapor infiltration, polymer impregnation pyrolysis (PIP), or any combination thereof.

The term “metallic” as used herein is indicative of a material that includes metal such as, but not limited to, titanium, iron, aluminum, stainless steel, and nickel alloys. A metallic material or an alloy can be a combination of at least two or more elements or materials, where at least one is a metal.

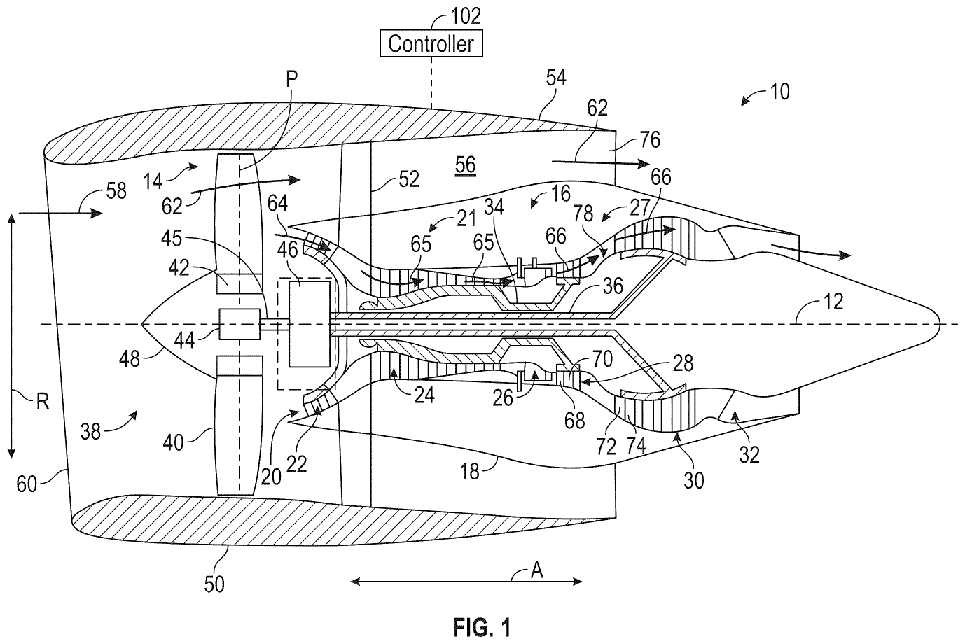

Referring now to the drawings, FIG. 1 is a schematic cross-sectional view of a turbine engine 10, taken along a longitudinal centerline axis 12 of the turbine engine 10, according to an embodiment of the present disclosure. As shown in FIG. 1, the turbine engine 10 defines an axial direction A (extending parallel to the longitudinal centerline axis 12 provided for reference) and a radial direction R that is normal to the axial direction A. In general, the turbine engine 10 includes a fan section 14 and a turbo-engine 16 disposed downstream from the fan section 14.

The turbo-engine 16 includes, in serial flow relationship, a compressor section 21, a combustion section 26, and a turbine section 27. The turbo-engine 16 is substantially enclosed within an outer casing 18 that is substantially tubular and defines a turbo-engine inlet 20 that is annular about the longitudinal centerline axis 12. As schematically shown in FIG. 1, the compressor section 21 includes a booster or a low pressure (LP) compressor 22 followed downstream by a high pressure (HP) compressor 24. The combustion section 26 is downstream of the compressor section 21. The turbine section 27 is downstream of the combustion section 26 and includes a high pressure (HP) turbine 28 followed downstream by a low pressure (LP) turbine 30. The turbo-engine 16 further includes a jet exhaust nozzle section 32 that is downstream of the turbine section 27, a high-pressure (HP) shaft 34 or a spool, and a low-pressure (LP) shaft 36. The HP shaft 34 drivingly connects the HP turbine 28 to the HP compressor 24. The HP turbine 28 and the HP compressor 24 rotate in unison through the HP shaft 34. The LP shaft 36 drivingly connects the LP turbine 30 to the LP compressor 22. The LP turbine 30 and the LP compressor 22 rotate in unison through the LP shaft 36. The compressor section 21, the combustion section 26, the turbine section 27, and the jet exhaust nozzle section 32 together define a turbo-engine air flow path.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. In the case of a variable pitch fan, the plurality of fan blades 40 are rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the longitudinal centerline axis 12 via a fan shaft 45 that is powered by the LP shaft 36 across a power gearbox, also referred to as a gearbox assembly 46. In this way, the fan 38 is drivingly coupled to, and powered by, the turbo-engine 16, and the turbine engine 10 is an indirect drive engine. The gearbox assembly 46 is shown schematically in FIG. 1. The gearbox assembly 46 is a reduction gearbox assembly for adjusting the rotational speed of the fan shaft 45 and, thus, the fan 38 relative to the LP shaft 36 when power is transferred from the LP shaft 36 to the fan shaft 45.

Referring still to the exemplary embodiment of FIG. 1, the disk 42 is covered by a fan hub 48 that is aerodynamically contoured to promote an airflow through the plurality of fan blades 40. In addition, the fan section 14 includes an annular fan casing or a nacelle 50 that circumferentially surrounds the fan 38 and at least a portion of the turbo-engine 16. The nacelle 50 is supported relative to the turbo-engine 16 by a plurality of outlet guide vanes 52 that are circumferentially spaced about the nacelle 50 and the turbo-engine 16. Moreover, a downstream section 54 of the nacelle 50 extends over an outer portion of the turbo-engine 16, and, with the outer casing 18, defines a bypass airflow passage 56 therebetween.

During operation of the turbine engine 10, a volume of air 58 enters the turbine engine 10 through an inlet 60 of the nacelle 50 or the fan section 14. As the volume of air 58 passes across the fan blades 40, a first portion of air, also referred to as bypass air 62, is routed into the bypass airflow passage 56, and a second portion of air, also referred to as turbo-engine air 64, is routed into the upstream section of the turbo-engine air flow path through the turbo-engine inlet 20 of the LP compressor 22. The pressure of the turbo-engine air 64 is then increased, generating compressed air 65. The compressed air 65 is routed through the HP compressor 24 and into the combustion section 26, where the compressed air 65 is mixed with fuel and ignited to generate combustion gases 66.

The combustion gases 66 are routed into the HP turbine 28 and expanded through the HP turbine 28 where a portion of thermal energy or kinetic energy from the combustion gases 66 is extracted via one or more stages of HP turbine stator vanes 68 and HP turbine rotor blades 70 that are coupled to the HP shaft 34. This causes the HP shaft 34 to rotate, thereby supporting operation of the HP compressor 24 (self-sustaining cycle). In this way, the combustion gases 66 do work on the HP turbine 28. The combustion gases 66 are then routed into the LP turbine 30 and expanded through the LP turbine 30. Here, a second portion of the thermal energy or the kinetic energy is extracted from the combustion gases 66 via one or more stages of LP turbine stator vanes 72 and LP turbine rotor blades 74 that are coupled to the LP shaft 36. This causes the LP shaft 36 to rotate, thereby supporting operation of the LP compressor 22 (self-sustaining cycle) and rotation of the fan 38 via the gearbox assembly 46. In this way, the combustion gases 66 do work on the LP turbine 30.

The combustion gases 66 are subsequently routed through the jet exhaust nozzle section 32 of the turbo-engine 16 to provide propulsive thrust. Simultaneously, the bypass air 62 is routed through the bypass airflow passage 56 before being exhausted from a fan nozzle exhaust section 76 of the turbine engine 10, also providing propulsive thrust. The HP turbine 28, the LP turbine 30, and the jet exhaust nozzle section 32 at least partially define a hot gas path 78 for routing the combustion gases 66 through the turbo-engine 16.

A controller 102 is in communication with the turbine engine 10 for controlling aspects of the turbine engine 10. For example, the controller 102 is in two-way communication with the turbine engine 10 for receiving signals from various sensors and control systems of the turbine engine 10 and for controlling components of the turbine engine 10, as detailed further below. The controller 102, or components thereof, may be located onboard the turbine engine 10, onboard the aircraft, or can be located remote from each of the turbine engine 10 and the aircraft. The controller 102 can be a Full Authority Digital Engine Control (FADEC) that controls aspects of the turbine engine 10.

The controller 102 may be a standalone controller or may be part of an engine controller to operate various systems of the turbine engine 10. In this embodiment, the controller 102 is a computing device having one or more processors and a memory. The one or more processors can be any suitable processing device, including, but not limited to, a microprocessor, a microcontroller, an integrated circuit, a logic device, a programmable logic controller (PLC), an application specific integrated circuit (ASIC), or a Field Programmable Gate Array (FPGA). The memory can include one or more computer-readable media, including, but not limited to, non-transitory computer-readable media, a computer readable non-volatile medium (e.g., a flash memory), a RAM, a ROM, hard drives, flash drives, or other memory devices.

The memory can store information accessible by the one or more processors, including computer-readable instructions that can be executed by the one or more processors. The instructions can be any set of instructions or a sequence of instructions that, when executed by the one or more processors, cause the one or more processors and the controller 102 to perform operations. The controller 102 and, more specifically, the one or more processors are programmed or configured to perform these operations, such as the operations discussed further below. In some embodiments, the instructions can be executed by the one or more processors to cause the one or more processors to complete any of the operations and functions for which the controller 102 is configured, as will be described further below. The instructions can be software written in any suitable programming language or can be implemented in hardware. Additionally, or alternatively, the instructions can be executed in logically or virtually separate threads on the processors. The memory can further store data that can be accessed by the one or more processors.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. The turbine engine 10 may also be a direct drive engine, which does not have a power gearbox. The fan speed is the same as the LP shaft speed for a direct drive engine. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, turbojet engines, turboprop, turboshaft engines, or aeroderivative ground based engines.

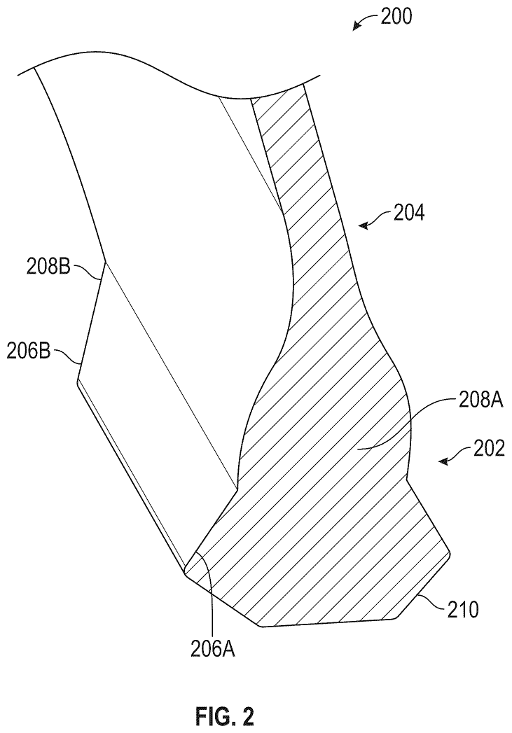

FIG. 2 is a partial cross-sectional view of a dovetail portion 202 (root portion) of a fan blade 200, according to an embodiment of the present disclosure. The fan blade 200 includes the dovetail portion 202 and an airfoil portion 204. The dovetail portion 202 is located at a radial inner end of the fan blade 200. The dovetail portion 202 extends between a first axial end 206A of the fan blade 200 and a second axial end 206B of the fan blade 200. The dovetail portion 202 generally has a first flat face 208A at the first axial end 206A of the fan blade 200 and a second flat face 208B at the second axial end 206B of the fan blade 200. The dovetail portion 202 has an edge 210. In an embodiment, the edge 210 has a trapezoid profile, as shown in FIG. 2. However, the edge 210 also can have another shape. The dovetail portion 202 is configured to be inserted into a disk slot of a rotor hub (not shown).

The fan blade 200 may be made from a composite material such as a carbon fiber reinforced material. During manufacturing of the fan blade 200, a plurality of composite plies of composite material are laid on top of each other and a specific sequencing of the layup of the composite plies is used. For example, the plurality of composite plies of the composite material of the fan blade 200 are laid up in a desired sequence pattern. After manufacture of the fan blade 200, various validations on correct sequencing of the layup of the plurality of composite plies of the composite material are made to ensure the layup of the plurality of composite plies of the composite material satisfies desired specifications of the fan blade 200, for example.

An image of the first flat face 208A and/or an image of the second flat face 208B of the dovetail portion 202 of the fan blade 200 are captured under desired lighting conditions to show light reflection patterns corresponding to a plurality of reinforcing fibers of the plurality of composite plies of the composite material of the fan blade 200. The light reflection patterns corresponding to reinforcing fibers within the plurality of composite plies of the fan blade 200 are captured along a cross section of the plurality of composite plies on the image.

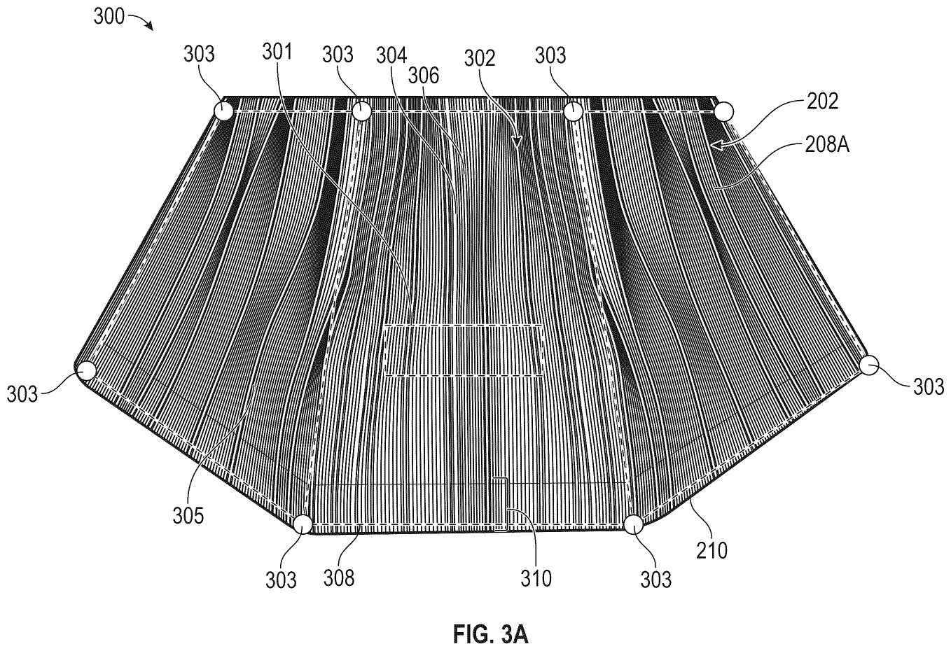

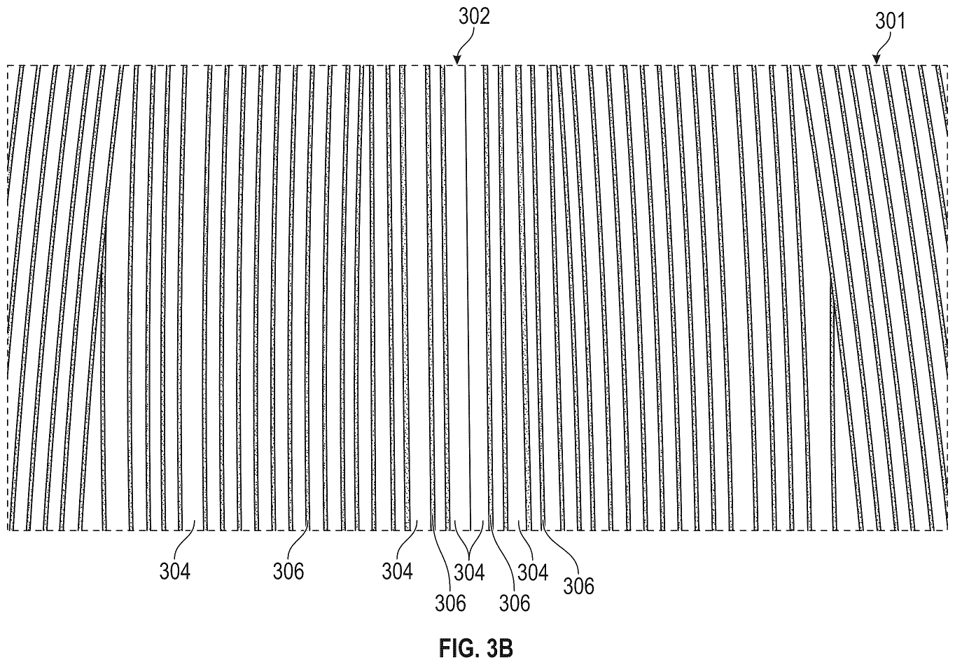

FIG. 3A is an image 300 of the first flat face 208A of the dovetail portion 202 of the fan blade 200, according to an embodiment of the present disclosure. FIG. 3B is an enlarged image portion 301 of the image 300 shown in FIG. 3A, according to an embodiment of the present disclosure. The image 300 and the enlarged image portion 301 show light reflection patterns 302. The light reflection patterns 302 are depicted as alternating white lines 304 and dark lines 306, as shown more clearly in FIG. 3B. The white lines 304 correspond to a first angular orientation of first reinforcing fibers within a first composite ply in the plurality of composite plies in the fan blade 200 and the dark lines 306 correspond to a second angular orientation of second reinforcing fibers within a second composite ply in the plurality of composite plies in the fan blade. For example, for the white lines 304, the first angular orientation can be about zero degrees. The first reinforcing fibers corresponding to the white lines 304 run parallel to the plane of FIGS. 3A and 3B in a first direction from a root (the dovetail portion 202) of the fan blade 200 to a tip (not shown) of the fan blade 200. The second reinforcing fibers corresponding to the dark lines 306 run in a second direction different from the first direction (for example, the second direction can be at an angle of 45 degrees relative to the first direction), from the first axial end 206A to the second axial end 206B (shown in FIG. 2) of the fan blade 200.

As shown in FIG. 3A, a plurality key points 303 of the fan blade 200 on the image 300 are selected to define an area 305. A profile line 308 is selected to extend along the edge 210 (also shown in FIG. 2) of the dovetail portion 202 of the fan blade 200, within the area 305 defined by the plurality of key points 303. A plurality of profile lines 310 can be selected extending parallel to the edge 210. For example, twenty (20) profile lines can be selected extending parallel to the edge 210. However, the selected number of the plurality profile lines 310 is not limited to twenty and can be any number greater than or equal to two. The number depends on the composite component, inspection requirements, and plies layup geometries. The number of profile lines 310 is selected so as to cover a sufficient extent of the plurality of reinforcing fibers within the area 305. A spacing or a gap between one profile line and an adjacent profile line can be selected as desired. The spacing or the gap may be determined by the resolution of the image. For example, the gap may be at least one pixel size to be able to distinguish features. In the current example, an appropriate number of profile lines of at least two (for example, six or more) can be selected within the range where plies spread approximately evenly along each profile line.

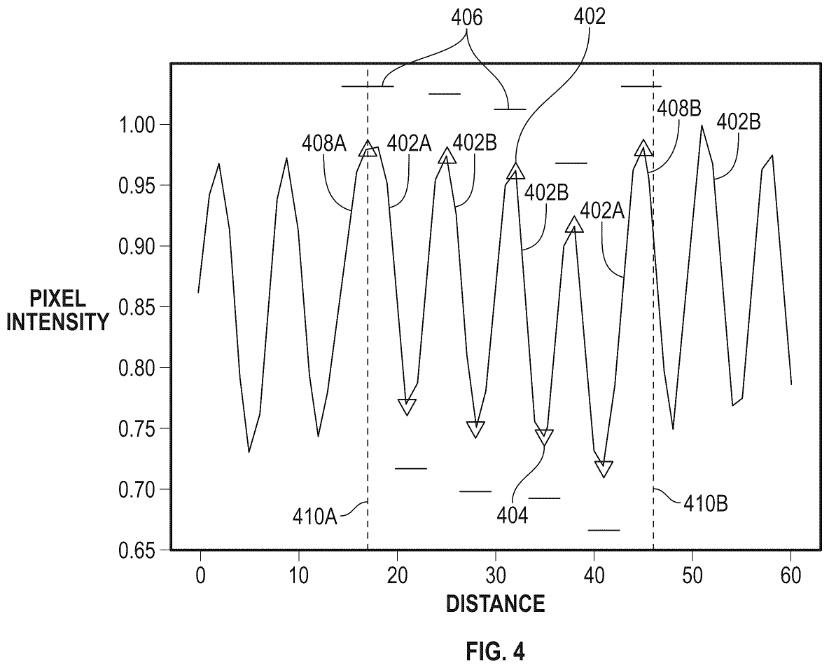

After selecting the profile line 308, a pixel intensity of the image 300 is measured and plotted along the profile line 308. FIG. 4 is a plot of the pixel intensity versus a distance along the profile line 308, according to an embodiment of the present disclosure. The x-axis represents a distance along the profile line 308 and the y-axis represents the pixel intensity. For example, as shown in FIG. 4, the pixel intensity can be normalized to one.

As shown in FIG. 4, the pixel intensity varies or oscillates between peaks 402 and troughs 404 as a function of the distance along the profile line 308. The peaks 402 in pixel intensity correspond to the white lines 304 and the troughs 404 in pixel intensity correspond to the dark lines 306 (shown in FIG. 3B). As shown in FIG. 4, some peaks are wider than other peaks. A width of each peak 402 is plotted as a horizontal bar 406. Therefore, a first plurality of peaks 402A in the plurality of peaks 402 have a wider horizontal bar 406 than a second plurality of peaks 402B in the plurality of peaks 402. The first plurality of peaks 402A that are wider peaks provide evidence for a pack region border of composite plies. The expected pack region border of composite plies is shown as vertical dotted lines 410A and 410B. As shown in FIG. 4, a first wider peak 408A coincides with the vertical dotted line 410A and a second wider peak almost coincides with the vertical dotted line 410B indicating that there is agreement between the expected pack region border shown as vertical dotted lines 410A and 410B and measured wider peaks. The first wider peak 408A and the second wider peak 408B correspond to two white lines 304 next to each other without the presence of a black line between the two white lines 304. The two white lines 304 next to each other correspond to a double insert location.

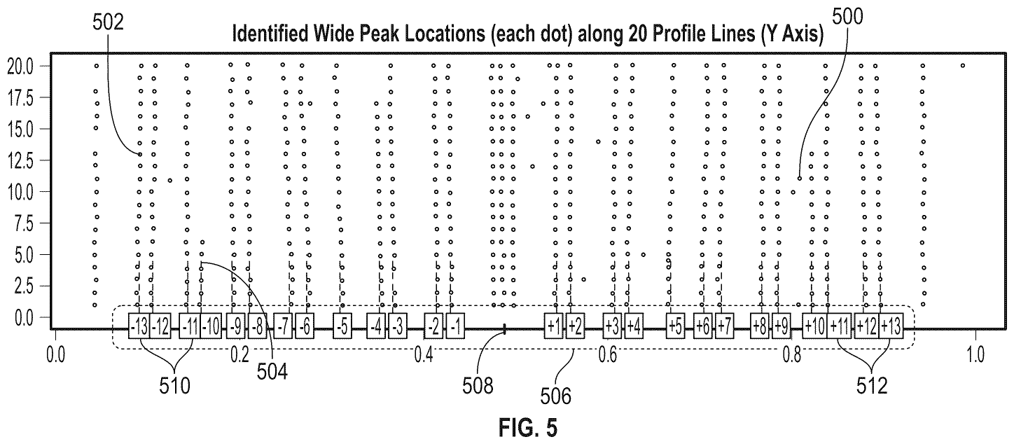

FIG. 5 is a plot of identified wider peak locations for a plurality (e.g., twenty) profile lines 310 versus a distance along each of the plurality of profile lines 310, according to an embodiment of the present disclosure. The x-axis represents a distance along the profile lines 310 and the y-axis represents a reference number (for example, from one to twenty) for each of the plurality of profile lines 310. As shown in FIG. 5, the distance can be normalized to one. The above measurement of pixel intensity is repeated for each profile line of the plurality of profile lines 310 and a dot 500 is plotted along the distance of each profile line each time a double insertion is measured or found. Each dot 500 corresponds to a wider peak location on a profile line of the plurality of profile lines 310. Therefore, a location of the double white lines can be recorded or plotted as dots 500 as a function of the distance along each profile line of the plurality of profile lines 310. As shown in FIG. 5, some vertically aligned dots 502, corresponding to wider peaks associated with the double lines, extend a totality of the plurality (twenty in the present example) of profile lines 310, while other vertically aligned dots 504, corresponding to wider peaks associated with double lines, extend only a certain number of the plurality of profile lines 310 less than the totality of the plurality of profile lines 310.

The dots corresponding to the wider peaks from the plurality of profile lines 310 are grouped to allow identification of double insert locations. The identification of double insert locations is referred to herein as density estimation. The identification of double insertion locations are compared with an as-expected template per component layup design specification. As a result, anomalous components can be identified in a controlled manufacturing process.

The values within the dotted box 506 along the x-axis represent counts of identified double insertion in reference to a middle 508 of the image, annotated negative numbers 510 of double insertion when located left of the middle 508, and positive numbers 512 of double insertion when located right of the middle 508.

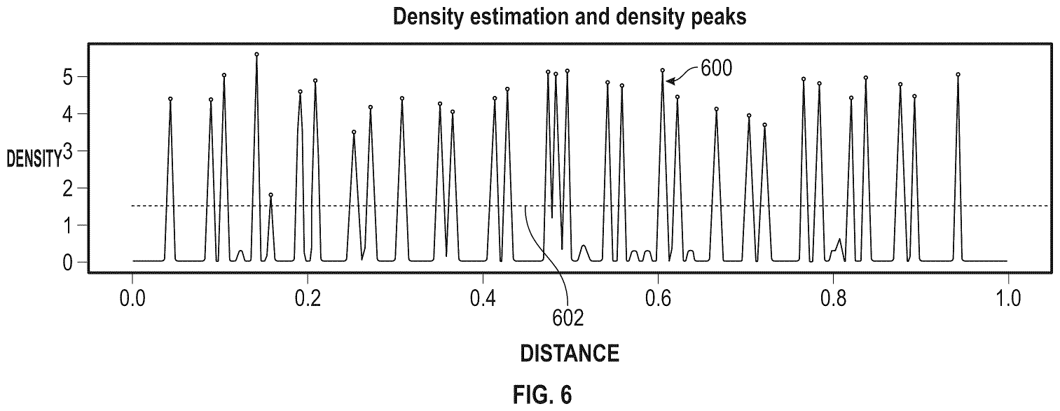

FIG. 6 is a plot of density estimation and density peaks versus the distance along the plurality of profile lines 310, according to an embodiment of the present disclosure. The x-axis represents the distance along the plurality of profile lines 310 (in this example, twenty) and the y-axis represents the density estimation. As shown in FIG. 6, the density estimation also varies as peaks and troughs reflecting the number of dots plotted vertically in the plot shown in FIG. 5.

Specifically, the density estimation is based on Kernel Density Estimation (KDE). A set (x₁, x₂, . . . , xₙ) represents samples drawn from some univariate distribution with an unknown probability density function of f at any given point x. The shape of the density function f can be estimated using its kernel density estimator given by the following expression (1).

$$\hat{f} ( x ) = \frac{1}{n} {\sum }_{i = 1}^{n} {K}_{h} ( x - {x}_{i} ) \qquad ( 1 )$$

where Kₕ is the kernel function, which has a bandwidth parameter h. There exist a number of commonly used kernel functions. In the present fan blade example, a so-called cosine kernel function can be used. The cosine kernel function is given by the following expression (2).

$${K}_{h} ( u ) = \frac{π}{4} cos ( \frac{π u}{2 h} ) , ∀ \vert \frac{u}{h} \vert \leq 1 \qquad ( 2 )$$

The parameter h is experimentally determined for a particular application. For the present application of measuring density for double insertion, each point obtained from the measurement step (as shown in FIG. 4 and FIG. 5) has a value along the x-axis. The values from all the points form the sample as described above (x₁, x₂, . . . , xₙ), where n is the total number of points detected. After applying the kernel density estimation technique, the function \hat{f}(x) is determined.

After the function \hat{f}(x) is determined, a value of any x can be plugged in to obtain the value of \hat{f}(x), as shown in FIG. 6. The peaks 600 of the density function \hat{f}(x) can be determined, as illustrated by the circle dot shown in FIG. 6. In FIG. 6, only the peaks 600 (annotated by the circle dots) whose values are above a threshold value 602, shown as a horizontal dotted line in FIG. 6, are taken into consideration. The threshold value 602, shown as the horizontal dotted line in FIG. 6, is experimentally determined. The overall objective is to identify a correct number and locations of double insertions. Several composite components (e.g., composite parts) can be tested with the method, and a threshold can be established so that tested normal composite components or parts can be correctly identified by moving the threshold. For example, the threshold can be selected using a grid search method based on detection results on a modest training dataset. The parameter that captures all true positives while minimizing false positives is chosen. The locations of the peaks having the circle dots above the noise threshold form the landmarks of interest in the identified patterns, which are then compared to an as-expected template of the plurality of composite plies to evaluate manufacturing for decisioning. A determination is made as to whether the landmarks of interest in the identified patterns match the as-expected template of the plurality of composite plies in the composite component. If the landmarks of interest in the identified patterns match the as-expected template of the plurality of composite plies in the composite component, the manufacturing is evaluated as satisfactory. If the landmarks of interest in the identified patterns do not match the as-expected template of the plurality of composite plies in the composite component, the anomaly or discrepancy in the composite component is identified and digitally recorded, and the manufacturing is evaluated as not satisfactory. The composite component is quarantined and submitted for further evaluation to assess the implication and a separate board to decide on accepting or rejecting the anomaly or the discrepancy. For example, indications are made that provide information on whether either too many or too few double-insert locations are detected. Since repeated-ply detections are a primary risk, the case when too many double-insert locations are detected is flagged as least satisfactory. When the manufacturing is evaluated as satisfactory, the composite component is labeled as being usable. When the manufacturing is evaluated as not satisfactory, the composite component is labeled as being not usable. In this latter case, results of the evaluation are provided to the manufacturer of the composite component in order for the manufacturer to make appropriate adjustments to the manufacturing process of the composite component. If the manufacturing is determined to be unacceptable, root cause analysis is performed and process improvement actions are taken. In addition, due to the digital record of the anomaly or the discrepancy, long term statistical analysis can be done. The digital record may contain the analyzed image and the results of the analysis, and any detection of discrepancies or anomalies.

According to an aspect to the present disclosure, a method of inspecting a composite component (e.g., a fan blade) having a plurality of composite plies includes (a) identifying key points of the composite component, (b) capturing an image of a cross section of the plurality of composite plies taken at the key points of the composite component, the image including light reflection patterns corresponding to a plurality of reinforcing fibers within the plurality of composite plies of the composite component, and (c) generating a plurality of profile lines along the image. The method also includes (d) processing along each of the plurality of profile lines to identify patterns corresponding to a layup of the plurality of reinforcing fibers. The method further includes (e) grouping the identified patterns from the plurality of profile lines. The method further includes (f) determining a noise threshold and ignoring noise identifications from individual profile lines. The method further includes (g) comparing the identified pattern to an as-expected template of the plurality of composite plies to evaluate a manufacturing process of the composition component and determining whether the identified pattern matches the as-expected template. The method further includes (h) outputting and storing the image and a result of the determining as a record, and when the identified patterns do not match the as-expected template of the plurality of composite plies in the composite component, further recording a discrepancy between the identified patterns and the as-expected template in the record.

In an embodiment, the method further includes, when the identified patterns match the as-expected template of the plurality of composite plies in the composite component, the manufacturing process of the composite component is evaluated as satisfactory, and when the identified patterns do not match the as-expected template of the plurality of composite plies in the composite component, the manufacturing process of the composite component is evaluated as not satisfactory.

In an embodiment, the identification of features including identification of double insertion locations is referred to as density estimation. The identifications of double insertion locations are compared with an as-expected template per component layup design specification.

Although the method of inspecting a composite component is described in the above paragraphs for application in a fan blade, the method is not limited to only a fan blade, but also can be applied to any aircraft component or to generally any composite component. The present method can be used to inspect aircraft component such as fan blades of a turbine engine of an aircraft or other components. The method can be used for inspection after manufacturing of a component or during manufacturing of the component. The method can be used for inspecting a component in-service for other defects. The method can be automated to provide inspection of components without intervention of a user or an operator. For example, the method can be implemented for a vision-based camera or other detection equipment.

A camera acquisition system and a computer with an HMI (human machine interface) running the above method can be used. The operator or the user, through the interface, can trigger a process where an image is automatically acquired, an analysis performed on the image, and results are displayed with any detection of discrepancies or anomalies (for example marked by colors), and a digital record is stored. The digital record may contain the analyzed image and the results of the analysis, and any detection of discrepancies or anomalies.

Further aspects are provided by the subject matter of the following clauses.

A method of inspecting a composite component having a plurality of composite plies, the method including capturing an image of a cross section of the plurality of composite plies, the image including light reflection patterns corresponding to a plurality of reinforcing fibers within the composite plies of the composite component, identifying key points of the composite component on the image to define an area of interest, generating a plurality of profile lines in the image within the area of interest defined by the key points, processing along each of the plurality of profile lines to identify patterns corresponding to a layup of the plurality of reinforcing fibers, grouping identified patterns from the plurality of profile lines, comparing the identified patterns to an as-expected template of the plurality of composite plies in the composite component to evaluate a manufacturing process of the composite component, determining whether the identified patterns match the as-expected template of the plurality of composite plies in the composite component, and outputting and storing the image and a result of the determining as a record, and when the identified patterns do not match the as-expected template of the plurality of composite plies in the composite component, further recording a discrepancy between the identified patterns and the as-expected template in the record.

The method according to the above clause, further including, after grouping the identified patterns, determining a noise threshold and ignoring noise identifications from individual profile lines in the plurality of profile lines.

The method according to any of the above clauses, wherein identifying the patterns includes identifying double insertion locations and comparing the double insertion locations with an as-expected template of the plurality of composite plies in the composite component.

The method according to any of the above clauses, wherein capturing the image includes capturing the image with a desired lighting condition to show the light reflection patterns corresponding to the plurality of reinforcing fibers.

The method according to any of the above clauses, wherein the light reflection patterns include alternating white lines and dark lines in the image, the white lines corresponding to a first angular orientation of first reinforcing fibers within a first composite ply in the plurality of composite plies in the composite component, and the dark lines corresponding to a second angular orientation of second reinforcing fibers within a second composite ply in the plurality of composite plies in the composite component.

The method according to any of the above clauses, wherein the composite component is a portion of a fan blade, first reinforcing fibers corresponding to the white lines run in a first direction from a root of the fan blade to a tip of the fan blade, and the second reinforcing fibers corresponding to the dark lines run in a second direction generally perpendicular to the first direction, from a first axial end of the fan blade to a second axial end of the fan blade.

The method according to any of the above clauses, wherein a number of the plurality of profile lines is selected to cover a sufficient extent of the plurality of reinforcing fibers.

The method according to any of the above clauses, wherein processing along each of the plurality of profile lines includes measuring a pixel intensity of the image along each of the plurality of profile lines.

The method according to any of the above clauses, further including plotting the pixel intensity along each of the profile lines.

The method according to any of the above clauses, wherein a plot of the pixel intensity along each of the plurality of profile lines includes a plurality of peaks and a plurality of troughs, the plurality of peaks corresponding to white lines in the image and the plurality of troughs correspond to dark lines in the image.

The method according to any of the above clauses, wherein a first plurality of peaks in the plurality of peaks corresponding to white lines are wider than a second plurality of peaks in the plurality of peaks, the first plurality of peaks providing evidence for a pack region border of composite plies.

The method according to any of the above clauses, wherein the first plurality of peaks that are wider correspond to two white lines next to each other without a presence of a black line between the two white lines.

The method according to any of the above clauses, further including plotting a dot along a distance of each profile line each time a double insertion is measured or found, a double insertion corresponding to a wider peak.

The method according to any of the above clauses, wherein some vertically aligned dots corresponding to wider peaks associated with the double insertion extend a totality of the plurality of profile lines, while other vertically aligned dots corresponding to wider peaks associated with double lines extend only a certain number of the plurality of profile lines fewer than the totality of the plurality of profile lines.

The method according to any of the above clauses, wherein grouping identified patterns includes grouping wider peaks in a plurality of peaks from the plurality of profile lines.

The method according to any of the above clauses, wherein values from all dots along the profile lines are input into a density function to determine peaks of the density function.

The method according to any of the above clauses, wherein the density function is based on kernel density estimation (KDE).

The method according to any of the above clause, wherein the kernel density estimation f(x) is based on the following expression:

$$\hat{f} ( x ) = \frac{1}{n} {\sum }_{i = 1}^{n} {K}_{h} ( x - {x}_{i} )$$

where Kₕ is the kernel function, which has a bandwidth parameter h, xᵢ correspond to measurement points of the sample (x1, x2, . . . , xn) such that n is a total number of points detected.

The method according to any of the above clauses, wherein a cosine kernel function is given by the following expression:

$${K}_{h} ( u ) = \frac{π}{4} cos ( \frac{π u}{2 h} ) , ∀ \vert \frac{u}{h} \vert \leq 1$$

wherein parameter h is experimentally determined for a particular application.

The method according to any of the above clauses, further including selecting a noise threshold and determining points of interest above the noise threshold to form landmarks of interest in the identified patterns.

The method according to any of the above clauses, further including comparing the landmarks of interest in the identified patterns to an as-expected template of the plurality of composite plies to evaluate a manufacturing process of the composite component.

The method according to any of the above clauses, wherein, if the landmarks of interest in the identified patterns match the as-expected template of the plurality of composite plies in the composite component, the manufacturing is evaluated as satisfactory and labeling the composite component as usable.

The method according to any of the above clauses, wherein if the landmarks of interest in the identified patterns do not match the as-expected template of the plurality of composite plies in the composite component, the manufacturing is evaluated as not satisfactory and labeling the composite component as not usable and submitting the composite component for further evaluation.

The method according to any of the above clauses, wherein capturing the image of the cross section of the plurality of composite plies comprises capturing the image of the cross section of the plurality of composite plies of a dovetail portion of a fan blade.

A system including a camera acquisition system and a computer with an HMI (human machine interface) in communication with the camera acquisition system, the system configured to implement a method of inspecting a composite component having a plurality of composite plies, the method including capturing an image of a cross section of the plurality of composite plies, the image including light reflection patterns corresponding to a plurality of reinforcing fibers within the composite plies of the composite component, identifying key points of the composite component on the image to define an area of interest, generating a plurality of profile lines in the image within the area of interest defined by the key points, processing along each of the plurality of profile lines to identify patterns corresponding to a layup of the plurality of reinforcing fibers, grouping identified patterns from the plurality of profile lines, comparing the identified patterns to an as-expected template of the plurality of composite plies in the composite component to evaluate a manufacturing process of the composite component, determining whether the identified patterns match the as-expected template of the plurality of composite plies in the composite component, and outputting and storing the image and a result of the determining as a record, and when the identified patterns do not match the as-expected template of the plurality of composite plies in the composite component, further recording a discrepancy between the identified patterns and the as-expected template in the record.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A method of inspecting a composite component having a plurality of composite plies, the method comprising:
capturing an image of a cross section of the plurality of composite plies, the image including light reflection patterns corresponding to a plurality of reinforcing fibers within the composite plies of the composite component;
identifying key points of the composite component on the image to define an area of interest;
generating a plurality of profile lines in the image within the area of interest defined by the key points;
processing along each of the plurality of profile lines to identify patterns corresponding to a layup of the plurality of reinforcing fibers;
grouping identified patterns from the plurality of profile lines;
comparing the identified patterns to an as-expected template of the plurality of composite plies in the composite component to evaluate a manufacturing process of the composite component;
determining whether the identified patterns match the as-expected template of the plurality of composite plies in the composite component; and
outputting and storing the image and a result of the determining as a record, and when the identified patterns do not match the as-expected template of the plurality of composite plies in the composite component, further recording a discrepancy between the identified patterns and the as-expected template in the record.

2. The method according to claim 1, further comprising, after grouping the identified patterns, determining a noise threshold and ignoring noise identifications from individual profile lines in the plurality of profile lines.

3. The method according to claim 1, wherein identifying the patterns comprises identifying double insertion locations and comparing the double insertion locations with an as-expected template of the plurality of composite plies in the composite component.

4. The method according to claim 1, wherein capturing the image comprises capturing the image with a desired lighting condition to show the light reflection patterns corresponding to the plurality of reinforcing fibers.

5. The method according to claim 1, wherein a number of the plurality of profile lines is selected to cover a sufficient extent of the plurality of reinforcing fibers.

6. The method according to claim 1, wherein the light reflection patterns comprise alternating white lines and dark lines in the image, the white lines corresponding to a first angular orientation of first reinforcing fibers within a first composite ply in the plurality of composite plies in the composite component, and the dark lines corresponding to a second angular orientation of second reinforcing fibers within a second composite ply in the plurality of composite plies in the composite component.

7. The method according to claim 6, wherein the composite component is a portion of a fan blade, first reinforcing fibers corresponding to the white lines run in a first direction from a root of the fan blade to a tip of the fan blade, and the second reinforcing fibers corresponding to the dark lines run in a second direction generally perpendicular to the first direction, from a first axial end of the fan blade to a second axial end of the fan blade.

8. The method according to claim 1, wherein processing along each of the plurality of profile lines comprises measuring a pixel intensity of the image along each of the plurality of profile lines.

9. The method according to claim 8, further comprising plotting the pixel intensity along each of the plurality of profile lines.

10. The method according to claim 9, wherein a plot of the pixel intensity along each of the plurality of profile lines includes a plurality of peaks and a plurality of troughs, the plurality of peaks corresponding to white lines in the image and the plurality of troughs correspond to dark lines in the image.

11. The method according to claim 10, wherein a first plurality of peaks in the plurality of peaks corresponding to white lines are wider than a second plurality of peaks in the plurality of peaks, the first plurality of peaks providing evidence for a pack region border of composite plies.

12. The method according to claim 11, wherein the first plurality of peaks that are wider correspond to two white lines next to each other without a presence of a black line between the two white lines.

13. The method according to claim 12, further comprising plotting a dot along a distance of each profile line of the plurality of profile lines each time a double insertion is measured or found, a double insertion corresponding to a wider peak.

14. The method according to claim 13, wherein some vertically aligned dots corresponding to wider peaks associated with the double insertion extend a totality of the plurality of profile lines, while other vertically aligned dots corresponding to wider peaks associated with double lines extend only a certain number of the plurality of profile lines fewer than the totality of the plurality of profile lines.

15. The method according to claim 10, wherein grouping identified patterns comprises grouping wider peaks in a plurality of peaks from the plurality of profile lines.

16. The method according to claim 15, wherein values from all dots along the profile lines are input into a density function to determine peaks of the density function.

17. The method according to claim 16, further comprising selecting a noise threshold and determining points of interest above the noise threshold to form landmarks of interest in the identified patterns.

18. The method according to claim 17, further comprising comparing the landmarks of interest in the identified patterns to an as-expected template of the plurality of composite plies to evaluate a manufacturing process of the composite component.

19. The method according to claim 18, wherein, if the landmarks of interest in the identified patterns match the as-expected template of the plurality of composite plies in the composite component, the manufacturing is evaluated as satisfactory and labeling the composite component as usable.

20. The method according to claim 18, wherein, if the landmarks of interest in the identified patterns do not match the as-expected template of the plurality of composite plies in the composite component, the manufacturing is evaluated as not satisfactory and labeling the composite component as not usable and submitting the composite component for further evaluation.
